(19) United States
(12) Patent Application Publication
(10) Pub. No.: US 2012/0113398 A1
(43) Pub. Date: May 10, 2012

(54) PROJECTION DISPLAY APPARATUS

(75) Inventors: Tomoya Terauchi, Osaka (JP); Masutaka Inoue, Osaka (JP); Susumu Tanase, Osaka (JP); Takaaki Abe, Osaka (JP)

(73) Assignee: SANYO ELECTRIC CO., LTD., Moriguchi-shi, Osaka (JP)

(21) Appl. No.: 13/263,449

(22) PCT Filed: Mar. 15, 2010
(86) PCT No.: PCT/JP2010/054331

§ 371 Date: Dec. 20, 2011

(30) Foreign Application Priority Data
Apr. 8, 2009 (JP) 2009-094141

(51) Int. Cl. G03B 21/20

(52) U.S. Cl. 353/85

(57) ABSTRACT

A projection display apparatus (100) includes a housing case (200) that houses a light source unit (110), a color separation and combination unit (140) for modulating the light emitted from the light source, and a projection unit (150) for projecting the light emitted from the color separation and combination unit (140) onto a projection plane (300). The projection display apparatus further includes: a first interface (190A) provided on a first lateral-surface side sidewall (250) and displaying detailed information on errors having occurred within the housing case; and a second interface (190B) provided on a front-surface-side side wall (220) and displaying the levels of the errors having occurred within the housing case.

### TECHNICAL FIELD

The invention relates to a projection display apparatus including a solid light source, an imager that modulates light emitted from the solid light source, and a projection unit that projects the light emitted from the imager onto a projection plane.

### BACKGROUND ART

In recent years, there is known a projection display apparatus including a housing case that houses a solid light source such as a laser light source, an imager that modulates light emitted from the solid light source, and a projection unit that projects the light emitted from the imager onto a projection plane.

Here, it is necessary to take a long distance between the projection unit and the projection plane so that an image is displayed on a large scale onto the projection plane. Therefore, there is proposed a projection display system intending to shorten the distance between the projection unit and the projection plane using a reflective mirror which reflects the light emitted from the projection unit back to the projection plane side (for example, Patent Document 1).

There is also proposed a projection display apparatus in which a message is output to stimulate aversive behavior of an intruder in case a human trespasses the surveillance area (for example, Patent Document 2).

In the case where a laser light source is used as the solid light source, if the light is emitted from a solid light source, then it is not preferable for a user to approach the housing case of the projection display apparatus.

### PRIOR ART DOCUMENT

### Patent Document

Patent Document 1: JP-A-2006-235516

Patent Document 2: JP-A-2004-070298

### SUMMARY OF THE INVENTION

A first aspect for solving the above problem is summarized as a projection display apparatus (projection display apparatus 100) comprising a housing case (housing case 200) that houses: a solid light source (red solid light source 111R, green solid light source 111G, blue solid light source 111B); an imager (DMD 500R, DMD 500G, DMD 500B) that modulates light emitted from the solid light source; and a projection unit (projection unit 150) that projects the light emitted from the imager onto a projection plane, the projection display apparatus further including: a first interface (digital indicator 613, for example) arranged on at least one sidewall (first lateral-surface-side sidewall 250, for example), of the both sidewalls forming the both ends of the housing case in a horizontal direction parallel to the projection plane, and that displays detailed information on an error having occurred within the housing case; and a second interface (LED indicator 616) arranged on any one of surfaces (front-surface-side sidewall 220, for example) except for an arrangement surface, of a plurality of surfaces sandwiched between the both sidewalls forming the both ends of the housing case, and that displays a level of the error having occurred within the housing case.

According to such a mode, detailed information of which the amount of data to be displayed increases is hidden from a position at which the user observes the projection plane. Therefore, it is possible to inhibit an obstruction to an image on which an error display is projected. On the other hand, from the position at which the projection plane is observed, the user is capable of knowing a state of the projection display apparatus and the level of the error. Thereby, the user can be prevented from approaching the housing case in a state where the light is emitted from a solid light source.

In the first mode, in the projection display apparatus, the first interface includes a terminal (for example, a power source terminal 610) capable of connecting to an external device. Thereby, the user is not required to approach the front-surface-side sidewall of the housing case in a case of plugging or unplugging the power cable in/from the power source terminal or the image input cable in/from the image terminal.

### BRIEF DESCRIPTION OF THE DRAWINGS

FIG. 1 is a diagram showing the configuration of a projection display apparatus 100 according to a first embodiment.

FIG. 2 is a diagram in which the projection display apparatus 100 according to the first embodiment is laterally viewed.

FIG. 3 is a diagram in which the projection display apparatus 100 according to the first embodiment is viewed from front.

FIG. 4 is a diagram in which the projection display apparatus 100 according to the first embodiment is viewed from above.

FIG. 5 is a diagram showing the configuration of a light source unit 110 according to the first embodiment.

FIG. 6 is a diagram showing the configuration of a color combination and separation unit 140 and a projection unit 150 according to the first embodiment.

FIG. 7 is a diagram showing the configuration on a first I/F 190A according to the first embodiment.

FIG. 8 is a diagram showing the configuration on a second I/F 190B according to the first embodiment.

FIG. 9 is a block diagram showing a control unit 700 arranged in the projection display apparatus 100 according to the first embodiment.

FIG. 10 is a perspective view showing the projection display apparatus 100 according to a first modification.

FIG. 11 is a diagram in which a projection display apparatus 100 according to a second embodiment is laterally viewed.

### MODES FOR CARRYING OUT THE INVENTION

Hereinafter, a projection display apparatus according to embodiments of the present invention is described with reference to drawings. In the following drawings, same or similar parts are denoted with same or similar reference numerals.

It will be appreciated that the drawings are schematically shown and the ratio and the like of each dimension are different from the real ones. Therefore, the specific dimensions, etc., should be determined in consideration of the following explanations. Of course, among the drawings, the dimensional relationship and the ratio are different.

### Overview of Embodiments

A projection display apparatus according to the present embodiment includes a housing case that houses a solid light source, an imager that modulates light emitted from the solid light source, and a projection unit that projects the light emitted from the imager onto a projection plane. The projection display apparatus includes a first interface that is arranged on at least one sidewall, out of the both sidewalls forming both ends of the housing case in a horizontal direction parallel to a projection plane and that displays detailed information on an error having occurred within the housing case; and a second interface that is arranged on any one of sidewalls except for an arrangement surface, out of a plurality of wall surfaces sandwiched between the both sidewalls forming the both ends of the housing case and that displays a level of the error having occurred within the housing case.

According to this embodiment, the detailed information of which the amount of data to be displayed increases is hidden from a position at which the user observes the projection plane. Therefore, it is possible to inhibit an obstruction to an image on which an error display is projected. On the other hand, from the position at which the projection plane is observed, the user is capable of knowing a state of the projection display apparatus and the level of the error. Thereby, the user can be prevented from approaching the housing case in a state where the light is emitted from a solid light source.

Further, in the projection display apparatus, the first interface includes a terminal connectable to an external device. Thereby, the user is not required to approach the front-surface-side sidewall of the housing case in a case of plugging or unplugging the power cable in/from the power source terminal or the image input cable in/from the image terminal.

### First Embodiment

### (Configuration of Projection Display Apparatus)

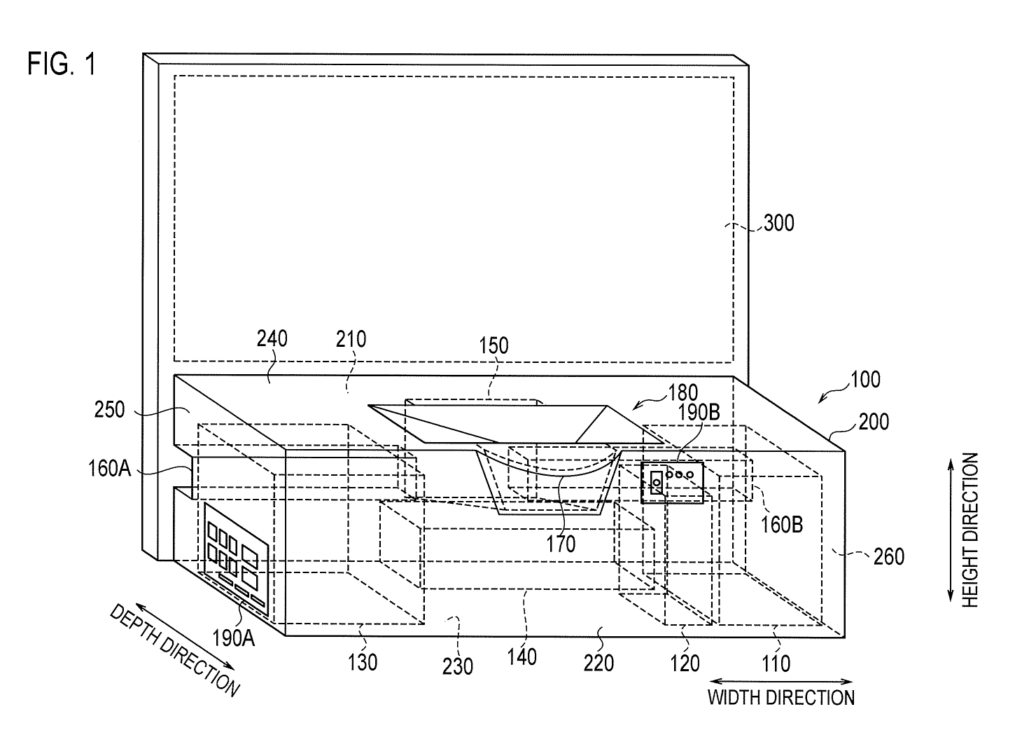

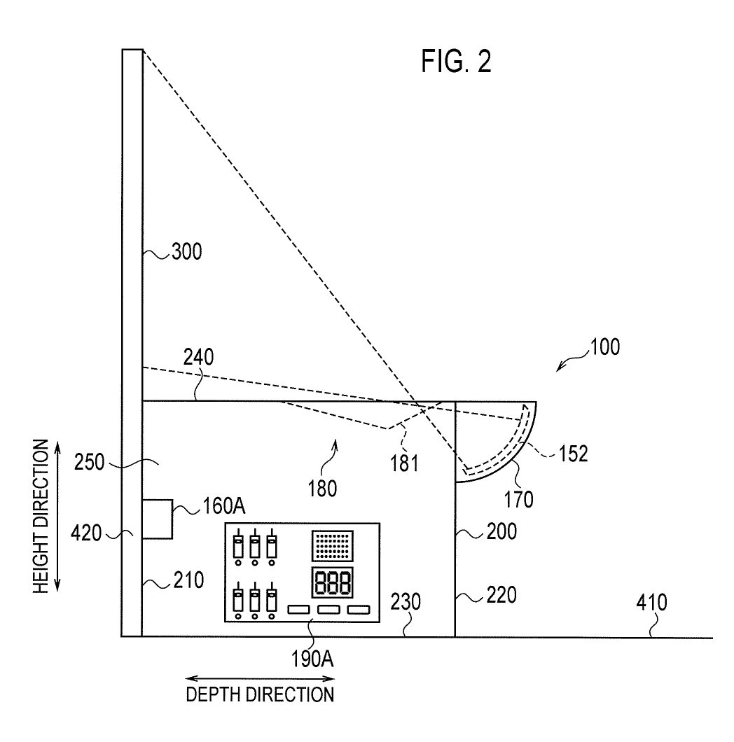

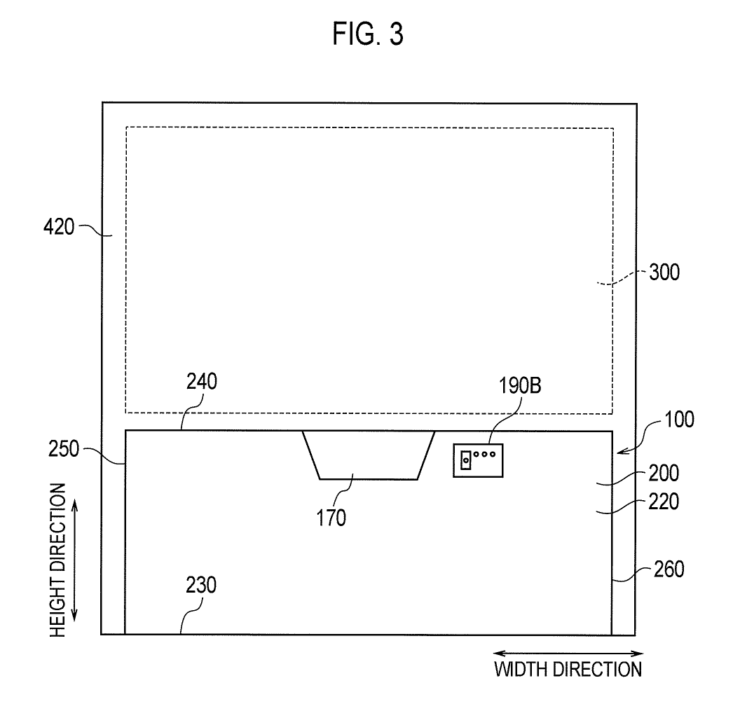

Hereinafter, the configuration of the projection display apparatus according to the first embodiment is described with reference to drawings. FIG. 1 is a perspective view showing the projection display apparatus 100 according to the first embodiment. FIG. 2 is a diagram in which the projection display apparatus 100 according to the first embodiment is laterally viewed. FIG. 3 is a diagram in which the projection display apparatus 100 according to the first embodiment is viewed from front.

As shown in FIG. 1, FIG. 2, and FIG. 3, the projection display apparatus 100 includes a housing case 200, and projects an image on a projection plane 300. The projection display apparatus 100 is arranged along a first arrangement surface (wall surface 420 shown in FIG. 2) and a second arrangement surface (floor surface 410 shown in FIG. 2) substantially vertical to the first arrangement surface.

Here, in the first embodiment, a case where the projection display apparatus 100 projects image light onto the projection plane 300 provided on the wall surface (wall surface projection) is provided. The arrangement of the housing case 200 in such a case is termed as “wall surface projection arrangement”. In the first embodiment, the first arrangement surface substantially parallel to the projection plane 300 is the wall surface 420.

In the first embodiment, the horizontal direction parallel to the projection plane 300 is termed as “width direction”. A normal line direction of the projection plane 300 is termed as “depth direction”. A direction orthogonal to both the width direction and the depth direction is termed as “height direction”.

The housing case 200 has an substantially rectangular parallelepiped shape. The size of the housing case 200 in the depth direction and the size of the housing case 200 in the height direction are smaller than the size of the housing case 200 in the width direction. The size of the housing case 200 in the depth direction is substantially equal to a projection distance from a reflective mirror (concave mirror 152 as shown in FIG. 2) to the projection plane 300. The size of the housing case 200 in the width direction is substantially equal to the size of the projection plane 300. The size of the housing case 200 in the height direction is determined according to a position at which the projection plane 300 is arranged.

Specifically, the housing case 200 includes a projection plane-side sidewall 210, a front-surface-side sidewall 220, a bottom surface plate 230, a top plate 240, a first lateral-surface-side sidewall 250, and a second lateral-surface-side sidewall 260.

The projection plane-side sidewall 210 is a plate member facing the first arrangement surface (wall surface 420 in the first embodiment) substantially parallel to the projection plane 300. The front-surface-side sidewall 220 is a plate member provided on the opposite side of the projection plane-side sidewall 210. The bottom surface plate 230 is a plate member facing the second arrangement surface (floor surface 410 in the first embodiment) other than the first arrnagement surface substantially parallel to the projection plane 300. The top plate 240 is a plate member provided on the opposite side of the bottom surface plate 230. The first lateral-surface-side sidewall 250 and the second lateral-surface-side sidewall 260 are plate members forming the both ends of the housing case 200 in the width direction.

The housing case 200 houses a light source unit 110, a power source unit 120, a cooling unit 130, a color separation and combination unit 140, and a projection unit 150. The projection plane-side sidewall 210 includes a projection plane-side recessed unit 160A and a projection plane-side recessed unit 160B. The front-surface-side sidewall 220 includes a front-surface-side protruding unit 170. The top plate 240 includes a top plate recessed unit 180. The first lateral-surface-side sidewall 250 includes a cable terminal 190.

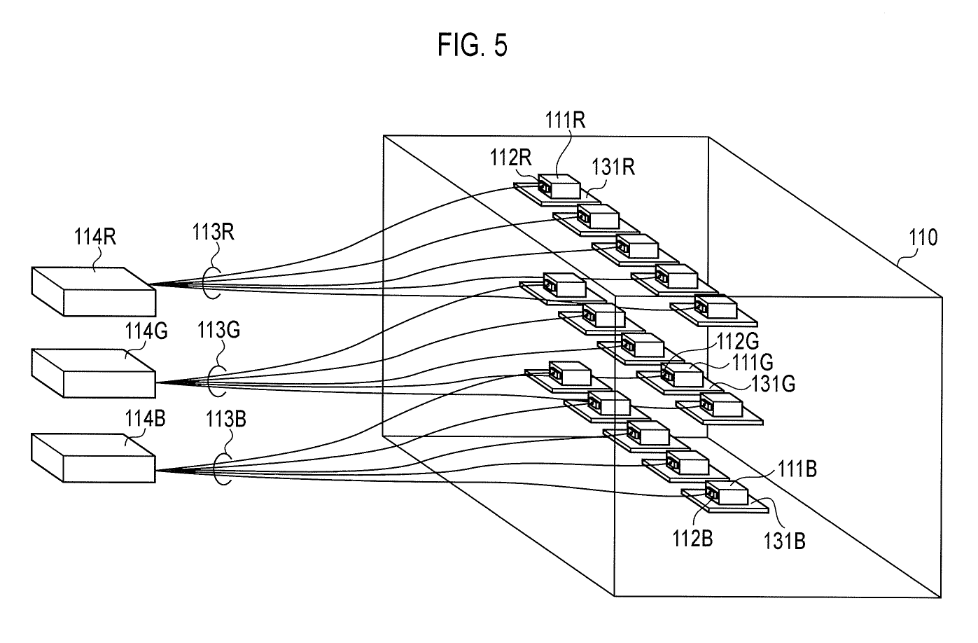

Each light source unit 110 is configured by a plurality of solid light sources (solid light source 111 shown in FIG. 5). Each solid light source is a light source such as an LD (Laser Diode). In the first embodiment, the light source unit 110 includes a red solid light source (red solid light source 111R as shown in FIG. 5) which emits a red component light R, a green solid light source (green solid light source 111G as shown in FIG. 5) which emits a green component light G, and a blue solid light source (blue solid light source 111B as shown in FIG. 5) which emits a blue component light B. A detailed description of the light source unit 110 is mentioned later (see FIG. 5).

The power source unit 120 is a unit supplies power to the projection display apparatus 100. For example, the power source unit 120 supplies power to the light source unit 110 and the cooling unit 130.

The cooling unit 130 is a unit cools a plurality of solid light sources provided in the light source unit 110. Specifically, the cooling unit 130 cools each solid light source by cooling a cooling jacket (cooling jacket. 131 as shown in FIG. 5) which mounts each solid light source.

Note that the cooling unit 130 cools a power source unit 120 or an imager (DMD 500 mentioned later) other than each solid light source.

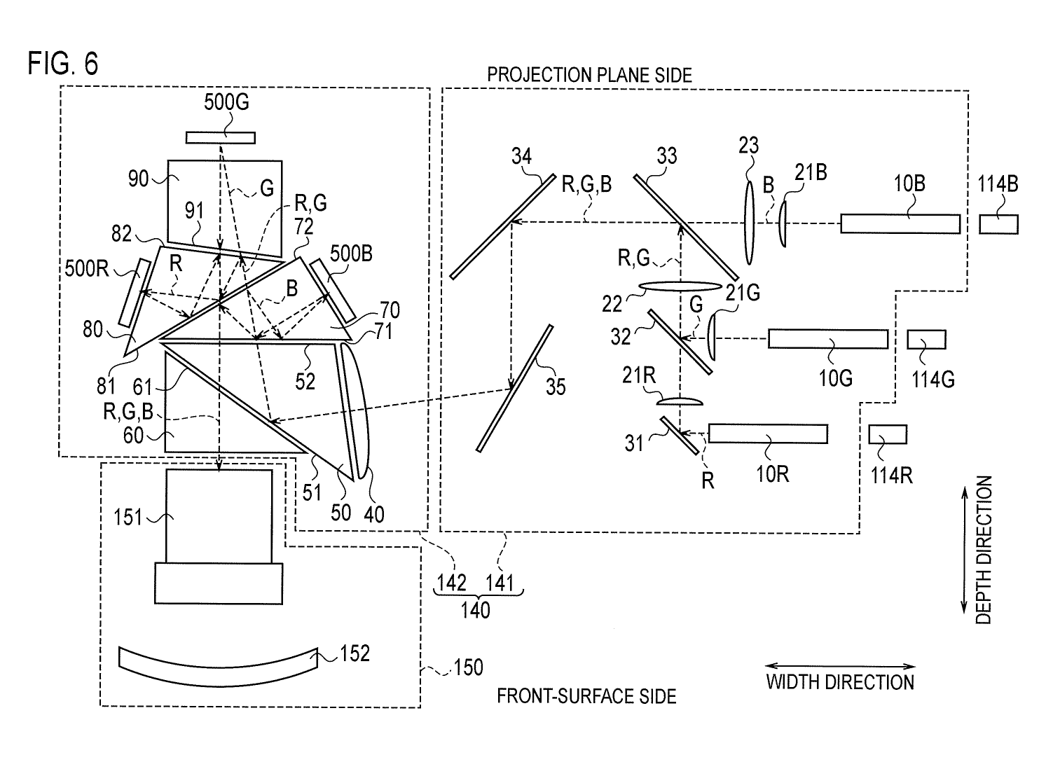

The color separation and combination unit 140 combines the red component light R emitted from the red solid light source, the green component light G emitted from the green solid light source, and the blue component light B emitted from the blue solid light source. Further, the color separation and combination unit 140 separates the combined light including the red component light R, the green component light G, and the blue component light B, and modulates the red component light R, the green component light G, and the blue component light B. Furthermore, the color separation and combination unit 140 re-combines the red component light R, the green component light G, and the blue component light B, and emits the image light onto the projection unit 150. A detailed description of the color separation and combination unit 140 is mentioned later (see FIG. 6).

The projection unit 150 projects the light (image light) emitted from the color separation and combination unit 140 onto the projection plane 300. Specifically, the projection unit 150 includes a projection lens cluster (projection lens cluster 151 as shown in FIG. 6) which projects the light emitted from the color separation and combination unit 140 onto the projection plane 300 and a reflective mirror (concave mirror 152 as shown in FIG. 6) which reflects the light emitted from the projection lens cluster to the projection plane 300 side. A detailed description of the projection unit 150 is mentioned later.

The projection plane-side recessed unit 160A and the projection plane-side recessed unit 160B are provided on the projection plane-side sidewall 210 and include a shape dented toward the inner side of the housing case 200. The projection plane-side recessed unit 160A and the projection plane-side recessed unit 160B extend to the end of the housing case 200. Ventilation holes which communicate to the inside of the housing case 200 are provided in the projection plane-side recessed unit 160A and the projection plane-side recessed unit 160B.

In the first embodiment, the projection plane-side recessed unit 160A and the projection plane-side recessed unit 160B extend along the width direction of the housing case 200. For example, in projection plane-side recessed unit 160A, an inlet lets in the air of the outside of the housing case 200 to the inside of the housing case 200 is provided as a ventilation hole. In the projection plane-side recessed unit 160B, an outlet discharges the air of the inside of the housing case 200 to outside of the housing case 200 is provided as a ventilation hole.

The front-surface-side protruding unit 170 is arranged on the front-surface-side sidewall 220, and includes a shape projecting outside the housing case 200. The front-surface-side protruding unit 170 is arranged in the substantially center of the front-surface-side sidewall 220 in the width direction of the housing case 200. A space formed by the front-surface-side protruding unit 170 inside the housing case 200 houses the reflective mirror (concave mirror 152 as shown in FIG. 6) which is provided in the projection unit 150.

The top plate recessed unit 180 is provided on the top plate 240 and has a shape dented to the inside the housing case 200. The top plate recessed unit 180 includes an inclined plane 181 descending toward the side of the projection plane 300. The inclined plane 181 includes a transmission area which transmits (projects) the light emitted from the projection unit 150 to the side of the projection plane 300. This transmission area is provided as one part of the inclined plane 181 by either a transparent glass or a synthetic resin. When the transmission area, rather than opening, is arranged, it is possible to prevent dust from entering inside the housing case 200.

A first interface (hereinafter, abbreviated as I/F) 190A is provided on the first lateral-surface-side sidewall 250, and examples thereof include a terminal such as a power source terminal, an image terminal, a breaker to various types of circuits, and an indicator indicates detailed error information.

Here, the I/F used herein denotes the projection display apparatus 100 and a connection portion with its external portion. Therefore, the I/F collectively includes a connection terminal with a power supply source such as a commercial power source, a connection terminal with an image supply source such as a personal computer, a switch such as a breaker operated by the user, an indicator that notifies the user of a state inside the projection display apparatus 100, and a reception unit that receives a signal transmitted by a user operation. Note that the first I/F 190A may be provided on the second lateral-surface-side sidewall 260.

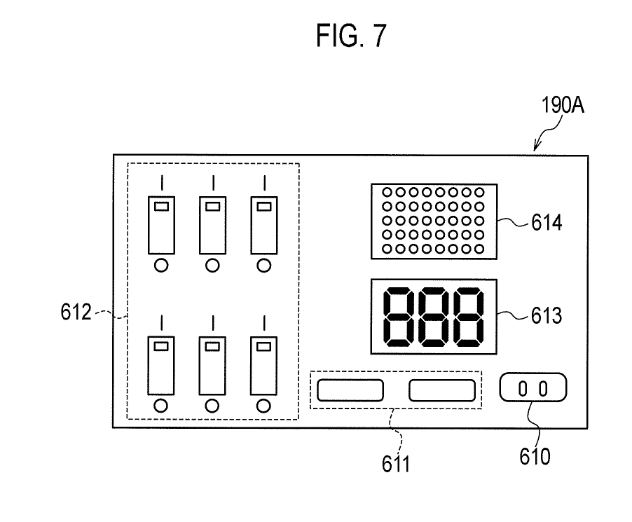

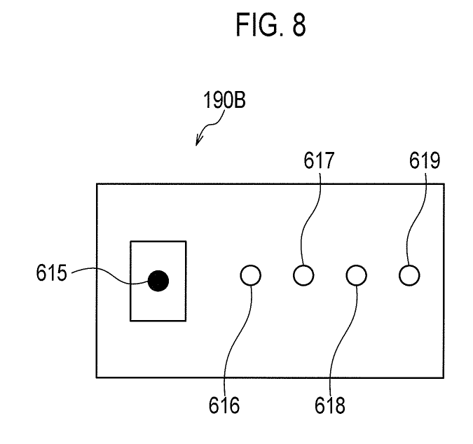

The second I/F 190B is provided on the front-surface-side sidewall 220 and is a display unit that notifies the user of a light reception unit from a remote controller (not shown) and a level of an error. The detailed description of the first I/F 190A and the second I/F 190B is mentioned later (see FIGS. 7 and 8).

### (Arrangement of Each Unit in the Width Direction of the Housing Case)

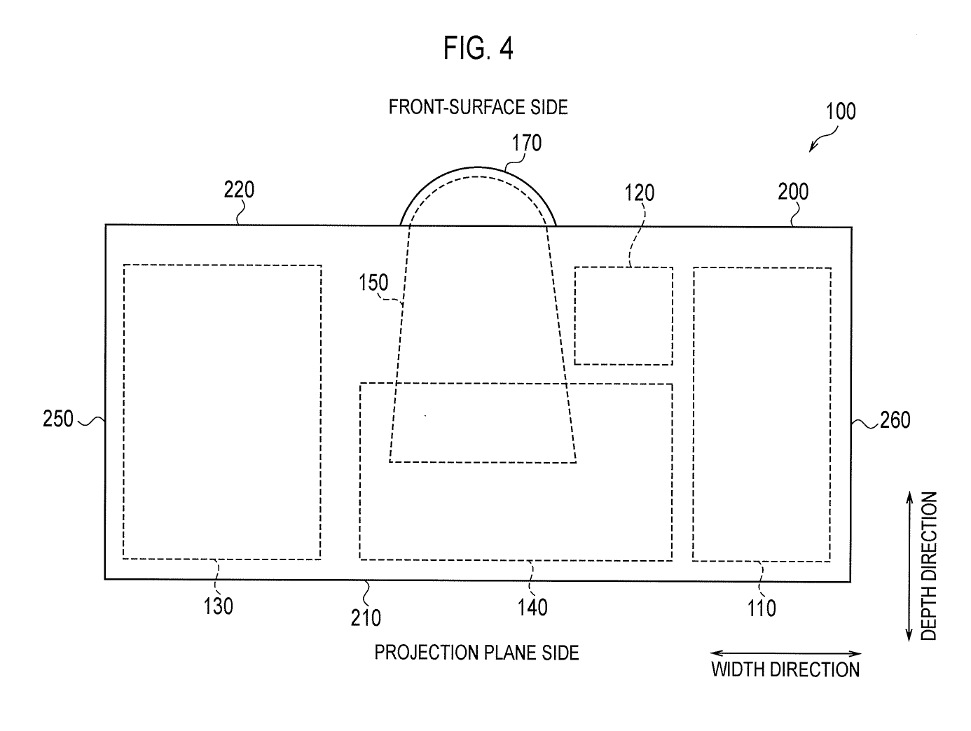

Hereinafter, the arrangement of each unit in the width direction according to the first embodiment will be described with reference to the drawings. FIG. 4 is a diagram in which the projection display apparatus 100 according to the first embodiment is viewed from above.

As shown in FIG. 4, the projection unit 150 is arranged in the substantially center of the housing case 200 in a horizontal direction (width direction of the housing case 200) parallel to the projection plane 300.

The light source unit 110 and the cooling unit 130 are arranged side by side with the projection unit 150 in the width direction of the housing case 200. Specifically, the light source unit 110 is arranged side by side with one side (the second lateral-surface-side sidewall 260 side) of the projection unit 150 in the width direction of the housing case 200. The cooling unit 130 is arranged side by side with the other side (the first lateral-surface side sidewall 250 side) of the projection unit 150 in the width direction of the housing case 200.

The power source unit 120 is arranged side by side with the projection unit 150 in the width direction of the housing case 200. Specifically, the power source unit 120 is arranged side by side on the light source 110 side relative to the projection unit 150 in the width direction of the housing case 200. Preferably, the power source unit 120 is arranged between the projection unit 150 and the light source unit 110.

### (Configuration of the Light Source Unit)

Hereinafter, the configuration of the light source unit according to the first embodiment will be described with reference to the drawings. FIG. 5 is a diagram showing the light source unit 110 according to the first embodiment.

As shown in FIG. 5, the light source unit 110 includes a plurality of red solid light sources 111R, a plurality of green solid light sources 111G, and a plurality of blue solid light sources 111B.

The red solid light source 111R is a red solid light source, such as an LD, emits the red component light R, as described above. The red solid light source 111R includes a head 112R, and an optical fiber 113R is connected to the head 112R.

The optical fiber 113R, which is connected to the head 112R of each red solid light source 111R, is bundled by a bundle unit 114R. In other words, the light emitted from each red solid light source 111R is transmitted by each optical fiber 113R, and is collected in the bundle unit 114R.

The red solid light source 111R is mounted on the cooling jacket 131R. For example, the red solid light source 111R is fixed to the cooling jacket 131R by a screw cramp, for example. The red solid light source 111R is cooled by the cooling jacket 131R.

The green solid light source 111G is a green solid light source, such as an LD, that emits the green component light G, as described above. The green solid light source 111G includes a head 112G, and an optical fiber 113G is connected to the head 112G.

The optical fiber 113G connected to the head 112G of each of green solid light sources 111G is bundled by a bundle unit 114R. That is, the light emitted from each green solid light source 111G is transmitted by each optical fiber 113G and is collected in the bundle unit 114R.

The green solid light source 111G is mounted on the cooling jacket 131G. For example, the green solid light source 111G is fixed to the cooling jacket 131G by a screw cramp, for example. The green solid light source 111G is cooled by the cooling jacket 131G.

The blue solid light source 111B is a blue solid light source, such as an LD, that emits the blue component light B, as described above. The blue solid light source 111B includes a head 112B, and an optical fiber 113B is connected to the head 112B.

The optical fiber 113B connected to the head 112B of each blue solid light source 111B is bundled by a bundle unit 114B. That is, the light emitted from each blue solid light source 111B is transmitted by each optical fiber 113B and is collected in the bundle unit 114B.

The blue solid light source 111B is mounted on the cooling jacket 131B. For example, the blue solid light source 111B is fixed to the cooling jacket 131B by a screw cramp, for example. The blue solid light source 111B is cooled by the cooling jacket 131B.

### (Configurations of the Color Combination and Separation Unit and the Projection Unit)

Hereinafter, the configurations of the color combination and separation unit and projection unit according to the first embodiment will be described with reference to the drawings. FIG. 6 is a diagram showing the configuration of the color combination and separation unit 140 and the projection unit 150 according to the first embodiment. In the first embodiment, a case where the projection display apparatus 100 of a type in which three DMDs (Digital Micro-mirror Device) are used is provided.

As shown in FIG. 6, the color separation and combination unit 140 includes a first unit 141 and a second unit 142.

The first unit 141 combines a red component light R, a green component light G, and a blue component light B and emits combined light including the red component light R, the green component light G, and the blue component light B to the second unit 142.

Specifically, the first unit 141 includes a plurality of rod integrators (a rod integrator 10R, a rod integrator 10G, and a rod integrator 10B), a lens cluster (a lens 21R, a lens 21G, a lens 21B, a lens 22, and a lens 23) and a mirror cluster (a mirror 31, a mirror 32, a mirror 33, a mirror 34, and a mirror 35).

The rod integrator 10R includes a light incident surface, a light emission surface, and a light reflection lateral surface provided across the outer periphery of the light incident surface and the outer periphery of the light emission surface. The rod integrator 10R makes uniform the red component light R which is emitted from the optical fiber 113R tied up by the bundle unit 114R. That is, the rod integrator 10R makes uniform the red component light R by reflecting it with the light reflection lateral surface.

The rod integrator 10G includes a light incident surface, a light emission surface, and a light reflection lateral surface provided across the outer periphery of the light incident surface and the outer periphery of the light emission surface. The rod integrator 10G makes uniform the green component light G which is emitted from the optical fiber 113G tied up by the bundle unit 114G. That is, the rod integrator 10G makes uniform the green component light G by reflecting it with the light reflection lateral surface.

The rod integrator 10B includes a light incident surface, a light emission surface, and a light reflection lateral surface provided across the outer periphery of the light incident surface and the outer periphery of the light emission surface. The rod integrator 10B makes uniform the blue component light B which is emitted from the optical fiber 113B tied up by the bundle unit 114B. That is, the rod integrator 10B makes uniform the blue component light B by reflecting it with the light reflection lateral surface.

Note that the rod integrator 10R, the rod integrator 10G, and the rod integrator 10B may be hollow rods of which the light reflection lateral surface is configured by the mirror surface.

The rod integrator 10R, the rod integrator 10G, and the rod integrator 10B may be solid rods configured by glass, for example.

Here, the rod integrator 10R, the rod integrator 10G, and the rod integrator 10B include a columnar shape extending along the horizontal direction (the width direction of the housing case 200) substantially parallel to the projection plane 300. That is, in the rod integrator 10R, a longitudinal direction of the rod integrator 10R is arranged along the substantially width direction of the housing case 200. Similarly, in the rod integrator 10G and the rod integrator 10B, longitudinal directions of the rod integrator 10G and the rod integrator 10B are arranged along the substantially width direction of the housing case 200.

The lens 21R is a lens which converts the red component light R into substantially parallel light so that the red component light R is irradiated with the DMD 500R. The lens 21G is a lens which converts the green component light G into substantially parallel light so that the green component light G is irradiated with the DMD 500G. The lens 21B is a lens which converts the blue component light B into substantially parallel light so that the blue component light B is irradiated with the DMD 500B.

The lens 22 is a lens that substantially causes the red component light R and the green component light G to substantially form image on the DMD 500R and the DMD 500G while suppressing the amplification of the red component light R and the green component light G. The lens 23 is a lens that substantially image the blue component light B onto DMD 500B while suppressing the amplification of the blue component light B.

The mirror 31 reflects the red component light R emitted from the rod integrator 10R. The mirror 32 is a dichroic mirror which reflects the green component light G emitted from the rod integrator 10G and transmits the red component light R. The mirror 33 is a dichroic mirror which transmits the blue component light B emitted form the rod integrator 10B and reflects the red component light R and the green component light G.

The mirror 34 reflects the red component light R, the green component light G, and the blue component light B. The mirror 35 reflects the red component light R, the green component light G, and the blue component light B to the side of the second unit 142. Note that, in FIG. 6, the respective configurations are shown in a plane view so as to simplify the description; however, the mirror 35 diagonally reflects the red component light R, the green component light G, and the blue component light B in the height direction.

The second unit 142 separates the combined light which includes the red component light R, the green component light G, and the blue component light B, and modulates the red component light R, the green component light G, and the blue component light B. Subsequently, the second unit 142 re-combines the red component light R, the green component light G, and the blue component light B and emits the image light toward the side of the projection unit 150.

Specifically, the second unit 142 includes a lens 40, a prism 50, a prism 60, a prism 70, a prism 80, a prism 90, and a plurality of DMDs; Digital Micromirror Devices (DMD 500R, DMD 500G, and DMD 500B).

The lens 40 is a lens which converts the light emitted from the first unit 141 into substantially parallel light so that each color component light is irradiated with each DMD.

The prism 50, which is configured by a translucent member, includes a plane 51 and a plane 52. An air gap is provided between the prism 50 (plane 51) and the prism 60 (plane 61), and an angle (incidence angle) at which the light emitted from the first unit 141 enters the plane 51 is larger than a total reflection angle, and therefore, the light emitted from the first unit 141 is reflected by the plane 51. On the other hand, an air gap is provided between the prism 50 (plane 52) and the prism 70 (plane 71); however, an angle (incidence angle) at which the light emitted from the first unit 141 enters the plane 52 is smaller than a total reflection angle, and therefore, the light reflected by the plane 51 transmits the plane 52.

The prism 60, which is configured by a translucent member, includes a plane 61.

The prism 70, which is configured by a translucent member, includes a plane 71 and a plane 72. An air gap is provided between the prism 50 (plane 52) and the prism 70 (plane 71), and an angle (incidence angle) at which the blue component light B reflected by the plane 72 and the blue component light B emitted from the DMD 500B enters the plane 71 is larger than a total reflection angle, and therefore, the blue component light B reflected by the plane 72 and the blue component light B emitted from the DMD 500B are reflected by the plane 71.

The plane 72 is a dichroic mirror surface that transmits the red component light R and the green component light G and reflects the blue component light B. Therefore, of the light reflected by the plane 51, the red component light R and the green component light G transmit the plane 72, and the blue component light B is reflected by the plane 72. The blue component light B reflected by the plane 71 is reflected by the plane 72.

The prism 80, which is configured by a translucent member, includes a plane 81 and a plane 82. An air gap is provided between the prism 70 (plane 72) and the prism 80 (plane 81), and an angle (incidence angle) at which the red component light R transmitting the plane 81 and being reflected by the plane 82 and the red component light R emitted from the DMD 500R enters again the plane 81 is larger than a total reflection angle, and therefore, the red component light R transmitting the plane 81 and being reflected by the plane 82 and the red component light R emitted from DMD 500R are reflected by the plane 81. On the other hand, an angle (incidence angle) at which the red component light R which is emitted from the DMD 500R and which is reflected by the plane 81 and then reflected by the plane 82 enters again the plane 81 is smaller than a total reflection angle, and therefore, the red component light R which is emitted from the DMD 500R and which is reflected by the plane 81 and then reflected by the plane 82 transmits the plane 81.

The plane 82 is a dichroic mirror plane that transmits the green component light G and reflects the red component light R. Therefore, of the light having transmitted the plane 81, the green component light G transmits the plane 82 and the red component light R is reflected by the plane 82. The red component light R reflected by the plane 81 is reflected by the plane 82. The green component light G emitted from the DMD 500G transmits the plane 82.

Here, the prism 70 separates the combined light including the red component light R and the green component light G from the blue component light B by the plane 72. The prism 80 separates the red component light R from the green component light G by the plane 82. That is, the prism 70 and the prism 80 function as color separating elements that separate each color component light.

Note that in the first embodiment, a cutoff wavelength of the plane 72 of the prism 70 is provided between a waveband corresponding to the green color and a waveband corresponding to the blue color. A cutoff wavelength of the plane 82 of the prism 80 is provided between a waveband corresponding to the red color and a waveband corresponding to the green color.

Meanwhile, the prism 70 combines the combined light including the red component light R and the green component light G, and the blue component light B by the plane 72. The prism 80 combines the red component light R and the green component light G by the plane 82. That is, the prism 70 and the prism 80 function as color combining elements that combine each color component light.

The prism 90, which is configured by a translucent member, includes a plane 91. The plane 91 is that transmit the green component light G. Note that the green component light G incident on the DMD 500G and the green component light G emitted from the DMD 500G transmit the plane 91.

The DMD 500R, the DMD 500G, and the DMD 500B are configured by plurality of micromirrors where the plurality of micromirrors are movable. Each micromirror is basically equivalent to one pixel. The DMD 500R switches over whether to reflect the red component light R toward the projection unit 150 side or not by changing the angle of each micromirror. Similarly, the DMD 500G and the DMD 500B switch over whether to reflect the green component light G and the blue component light B toward the projection unit 150 side or not by changing the angle of each micromirror.

The projection unit 150 includes a projection lens cluster 151 and a concave mirror 152.

The projection lens cluster 151 emits the light (image light) emitted from the color separation and combination unit 140 toward the concave mirror 152 side.

The concave mirror 152 reflects the light (image light) emitted from the projection lens cluster 151. The concave mirror 152 collecting the image light, and then scatters the image light over a wide angle. For example, the concave mirror 152 is an aspherical mirror including a recessed surface on the side of the projection lens cluster 151.

The image light collected by the concave mirror 152 transmits a transmission area provided on an inclined plane 181 of a top plate recessed unit 180 provided on the top plate 240. The transmission area provided on the inclined plane 181 preferably is provided in the vicinity of the position where the image light is collected by the concave mirror 152.

As described above, the concave mirror 152 is housed in the space formed by the front-surface-side protruding unit 170. For example, it is preferable that the concave mirror 152 is fixed inside the front-surface-side protruding unit 170. Further, the shape of an internal surface of the front-surface-side protruding unit 170 preferably is a shape along the concave mirror 152.

### (Configuration of First Interface)

Hereinafter, the configuration of the first interface according to the first embodiment is described with reference to drawings. FIG. 7 is a diagram showing the configuration of a first I/F 190A according to the first embodiment.

As shown in FIG. 7, the projection display apparatus 100 includes the first I/F 190A on the first lateral-surface-side sidewall 250.

A power source terminal 610 and two image terminals 611 are provided in a lower portion area of the first I/F 190A. In the left side area, a breaker 612 of the power supplied to various circuits, such as the light source unit 110, the cooling unit 130, and the DMD 500, via the power source unit 120 is provided. In the upper right area, a digital indicator 613 that indicate a content of an error having occurred within the projection display apparatus 100 in the form of an error number, and a matrix indicator 614 that indicate in which cooling fan, of a plurality of cooling fans (not shown) arranged within the projection display apparatus 100, the error has occurred are provided.

### (Configuration of Second Interface)

Hereinafter, the configuration of the second interface according to the first embodiment is described with reference to drawings. FIG. 8 is a diagram showing a second I/F 190B according to the first embodiment.

As shown in FIG. 8, the projection display apparatus 100 includes the second I/F 190B on the front-surface-side sidewall 220.

In the second I/F 190B, a light reception unit 615 that receive light in the form of a signal by way of infrared rays from a remote controller (not shown) is provided. The light reception unit 615 is provided at a position closest to the center of the housing case 200 in the second I/F 190B so as to receive light in the form of as many a signal as possible from all angles. In the second I/F 190B, four LED indicators 616, 617, 618, and 619 are provided.

The LED indicator 616 is an indicator for an infiltration detection system that indicate whether a system that detects infiltration of an object is operative or not in case where an object such as a human enters in the vicinity of the projection display apparatus 100. The LED indicator 616 is configured so that a green LED is lit when the system is operative.

The LED indicator 617 is an indicator which indicates the projection display apparatus 100 has turned into a black display after the infiltration of an object is detected by the infiltration detection system. The LED indicator 617 is configured so that a yellow LED is lit when the black display enters after detecting the infiltration of an object.

The LED indicator 618 is an indicator which indicates suspension of projection (suspension of the light emission of the solid light source 111) by the projection display apparatus 100 after an error has occurred in the consistent components within the projection display apparatus 100. The LED indicator 618 is configured so that a red LED is lit when the projection by the projection display apparatus 100 is suspended.

The LED indicator 619 is an indicator which indicates that various types of breakers 612 are ON after the projection display apparatus 100 is connected to a commercial power source. The LED indicator 619 is configured so that a blue LED is lit when the power is supplied to various types of circuits and a projection preparation state has entered.

### (Function of Projection Display Apparatus)

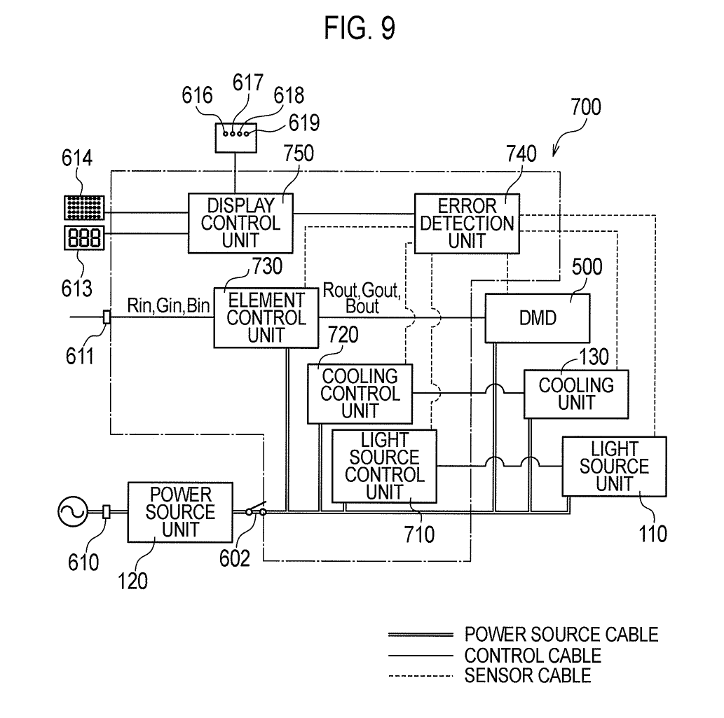

Hereinafter, the function of the projection display apparatus according to the first embodiment is described with reference to drawings. FIG. 9 is a block diagram showing a control unit 700 arranged in the projection display apparatus 100 according to the first embodiment.

Here, the control unit 700 includes a light source control unit 710, a cooling control unit 720, an element control unit 730, an error detection unit 740, and a display control unit 750.

The light source control unit 710 controls the power to the solid light source 111 provided in the light source unit 110. Specifically, the light source control unit 710 controls so that the light emitted from the solid light source 111 is not projected outside the projection display apparatus 100 when any abnormality occurs in the various types of consistent components configuring the projection display apparatus 100. That is, the light source control unit 710 switches OFF the input power to the light source unit 110. Note that the light source control unit 710 may instruct the power source unit 120 so that the input power to the entire projection display apparatus 100 is switched OFF.

The cooling control unit 720 receives information about a temperature of each constituent component configuring the projection display apparatus 100 from a thermistor (not shown). The cooling control unit 720 controls the cooling unit 130 based on the temperature information.

The element control unit 730 receives an image input signal from an external device such as a DVD or a TV chuner. The image input signal is a signal for each frame and includes a red input signal Rᵢₙ, a green input signal Gin, and a blue input signal Bᵢₙ. The element control unit 730 converts the image input signal into an image output signal. The image output signal is a signal for each frame and includes a red output signal Rₒᵤₜ, a green output signal Gₒᵤₜ, and a blue output signal Bₒᵤₜ. The element control unit 730 controls the DMD 500 based on the image output signal.

Upon obtaining the information which shows the entry of an object in the vicinity of the projection display apparatus 100, the element control unit 730 controls the DMD 500 so that the light emitted from the solid light source 111 is not projected outside the projection display apparatus 100. That is, the element control unit 730 displays black color in the DMD 500 when the object enters in the vicinity of the projection display apparatus 100.

The error detection unit 740 detects a place where abnormality occurs and a content of the abnormality when an abnormality (error) is generated in the various types of constituent components configuring the projection display apparatus 100. Specifically, the error detection unit 740 determines whether an object has infiltrated in the vicinity of the projection display apparatus 100 or determines whether an abnormality has occurred in the constituent components of the projection display apparatus 100. Further, in the case of the abnormality having occurred in the constituent component, the error detection unit 740 determines, together with a component number of the constituent components, contents of the abnormality such as a temperature abnormality detected from a thermistor and an operation abnormality detected by a voltmeter.

The display control unit 750 controls a digital indicator 613, a matrix indicator 614, and LED indicators 616, 617, 618, and 619 based on an error signal transmitted from the error detection unit 740. Specifically, a previously set error number is indicated on the digital indicator 613 based on the component number and the content of the abnormality specified by the error detection unit 740. Further, in the case of the cooling fan or the solid light source 111 in which a plurality of like components are arranged, the matrix indicator 614 is caused to indicate in which component the abnormality has occurred. That is, the detailed information relating to the abnormality having occurred inside the projection display apparatus 100 is indicated on the digital indicator 613 and the matrix indicator 614.

The display control unit 750 causes the LED indicators 617 and 618 to indicate a level of abnormality, such as the image is not projected due to an infiltration of an object in the vicinity of the projection display apparatus 100 or the image is not projected due to occurrence of an abnormality in the constituent component of the projection display apparatus 100. In addition, the display control unit 750 causes the LED indicators 616 and 619 to indicate information that is required by the user for a normal use, such as whether the infiltration detection system is operating or whether the current state of the projection display apparatus 100 is a projection preparation state after the projection display apparatus 100 has been connected to a commercial power source.

### (Operation and Effect)

In the first embodiment, the first I/F 190A is provided on at least one of the sidewalls, out of the both sidewalls (the first lateral-surface-side sidewall 250 and the second lateral-surface-side sidewall 260) of the housing case 200 in the width direction of the housing case 200. That is, the detailed information of which the amount of data to be displayed increases is hidden from a position where the user observes the projection plane. Therefore, it is possible to inhibit an obstruction to an image on which an error display is projected.

On the other hand, in the first embodiment, the second I/F 190B is provided on the front-surface-side sidewall 220 of the housing case 200 arranged on the opposite side of the projection plane 300. Therefore, from the position at which the projection plane is observed, the user is capable of knowing a state of the projection display apparatus 100 and the level of the error. As a result, it is possible to inhibit the user from approaching the housing case 200, in a state where the light is emitted from the solid light source 111.

In addition, in the first embodiment, the first. I/F 190A includes a power source terminal 610 and an image terminal 611 capable of connecting to an external device. That is, there is no need for the user to approach the front-surface-side sidewall 220 of the housing case 200 when plugging or unplugging the power source cable in/from the power source terminal 610 or plugging or unplugging the image input cable in/from the image terminal 611. Therefore, a possibility for the user to approach the front-surface-side sidewall 220 of the housing case 200 is reduced.

### First Modification

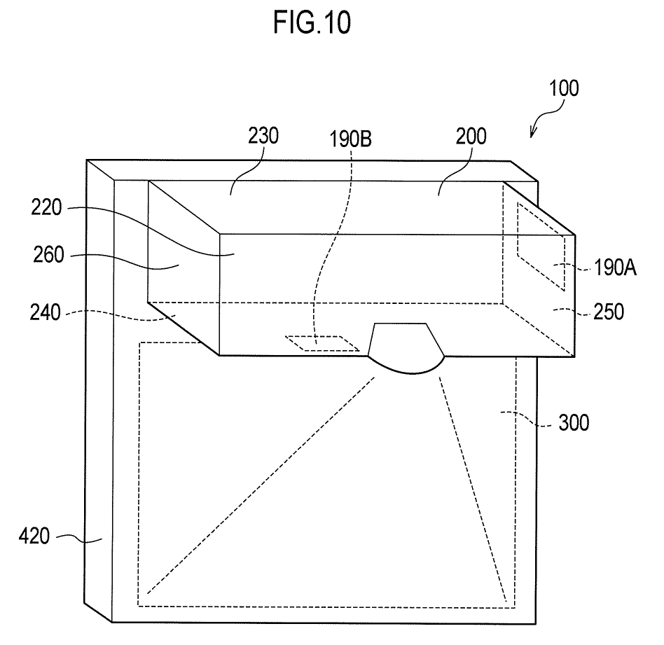

Hereinafter, a first modification of the first embodiment is described with reference to drawings. The description below is based primarily on the differences from the first embodiment. FIG. 10 is a perspective view showing the projection display apparatus 100 according to the first modification.

Specifically, in the first embodiment, the second I/F 190B is provided on the front-surface-side sidewall 220. On the other hand, in the first modification, the second I/F 190B is provided on the top plate 240.

As shown in FIG. 10, a case where the projection display apparatus 100 is installed when the bottom surface plate 230 of the projection display apparatus 100 is oriented toward a ceiling is provided. When the second I/F 190B is provided on the top plate 240 rather than on the front-surface-side sidewall 220 depending on the height where the projection display apparatus 100 is installed, it is easier to observe the LED indicators 616, 617, 618 and 619 from the user side. Specifically, upon installment on the ceiling (for example, with a height of 5 m or above) of a stage in a large hall, it is considered that it is easier for the user to observe the top plate 240. In such a case, the second I/F 190B may be provided on the top plate 240.

### Second Embodiment

Hereinafter, a second embodiment is described with reference to drawings. The description below is based primarily on the differences from the first embodiment.

Specifically, in the first embodiment, a case where the projection display apparatus 100 projects the image light onto the projection plane 300 provided on the wall surface is provided. On the other hand, in the second embodiment, a case where the projection display apparatus 100 projects image light onto the projection plane 300 provided on the floor surface (floor surface projection) is provided. The arrangement of the housing case 200 in such a case is termed as “floor surface projection arrangement”.

### (Configuration of Projection Display Apparatus)

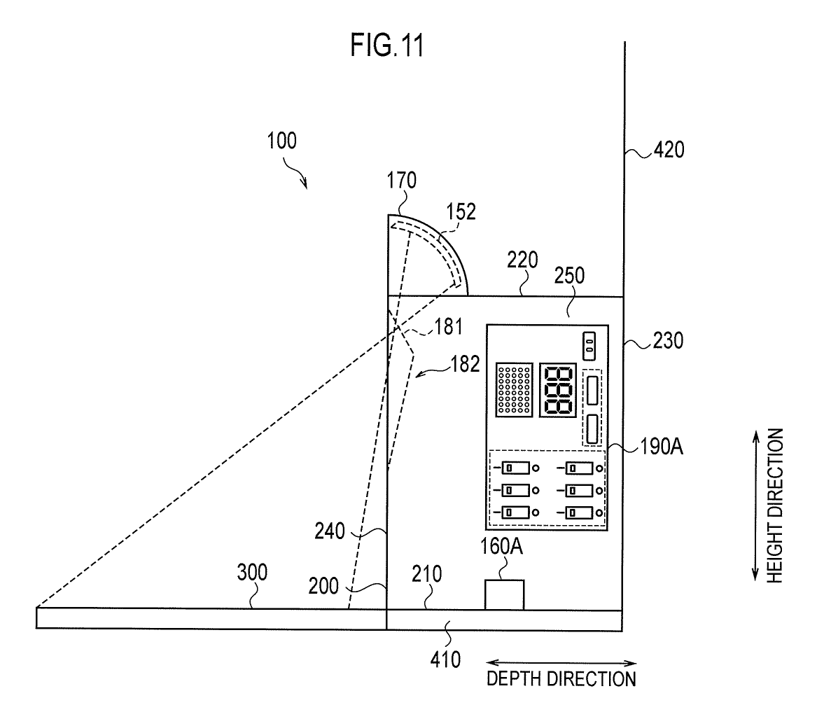

Hereinafter, the configuration of the projection display apparatus according to the second embodiment is described with reference to drawings. FIG. 11 is a diagram in which the projection display apparatus 100 according to the second embodiment is laterally viewed.

As shown in FIG. 11, the projection display apparatus 100 projects the image light onto the projection plane 300 provided on the floor surface (floor surface projection). In the second embodiment, the first arrangement surface substantially parallel to the projection plane 300 is the floor surface 420. The second arrangement surface substantially vertical to the first arrangement surface is the wall surface 420.

In the second embodiment, the horizontal direction parallel to the projection plane 300 is termed as “width direction”. A normal line direction of the projection plane 300 is termed as “height direction”. A direction orthogonal to both the width direction and the height direction is termed as “depth direction”.

In the second embodiment, the housing case 200 has an substantially rectangular parallelepiped shape, similar to the first embodiment. The size of the housing case 200 in the depth direction and the size of the housing case 200 in the height direction are smaller than the size of the housing case 200 in the width direction. The size of the housing case 200 in the height direction is substantially equal to a projection distance from a reflective mirror (concave mirror 152 as shown in FIG. 2) to the projection plane 300. The size of the housing case 200 in the width direction is substantially equal to the size of the projection plane 300. The size of the housing case 200 in the depth direction is determined according to the distance from the wall surface 420 to the projection plane 300.

The projection plane-side sidewall 210 is a plate member facing the first arrangement surface (floor surface 420 in the second embodiment) substantially parallel to the projection plane 300. The front-surface-side sidewall 220 is a plate member provided on the opposite side of the projection plane-side sidewall 210. The top plate 240 is a plate member provided on the opposite side of the bottom surface plate 230. The bottom surface plate 230 is a plate member facing the second arrangement surface (wall surface 420 in the second embodiment) other than the first arrangement surface substantially parallel to the projection plane 300. The first lateral-surface-side sidewall 250 and the second lateral-surface-side sidewall 260 are plate members forming the both ends of the housing case 200 in the width direction.

### Other Embodiments

The present invention is explained through the above embodiments, but it must not be assumed that this invention is limited by the statements and drawings constituting a part of this disclosure. From this disclosure, various alternative embodiments, examples, and operational technologies will become apparent to those skilled in the art.

In the first embodiment, the projection plane 300 is arranged on the wall surface 420 on which the housing case 200 is arranged; however, the embodiment is not limited thereto. The projection plane 300 may be arranged at a position deeper than the wall surface 420, in the direction away from the housing case 200.

In the second embodiment, the projection plane 300 is arranged on the floor surface 410 on which the housing case 200 is arranged; however, the embodiment is not limited thereto. The projection plane 300 may be arranged at a position lower than the floor surface 410.

In this embodiment, the DMD (Digital Micromirror Device) is provided as an example of the imager. The imager may be a transparent liquid crystal panel, and may also be a reflective liquid crystal panel.

### INDUSTRIAL APPLICABILITY

According to the present invention, it is possible to provide a projection display apparatus capable of preventing a user from approaching a housing case in a state where light is emitted from a solid light source.

1. A projection display apparatus comprising a housing case that houses: a solid light source; an imager that modulates light emitted from the solid light source; and a projection unit that projects the light emitted from the imager onto a projection plane, the projection display apparatus further comprising:
a first interface arranged on at least one sidewall, of the both sidewalls forming the both ends of the housing case in a horizontal direction parallel to the projection plane, and that displays detailed information on an error having occurred within the housing case; and
a second interface arranged on any one of surfaces except for an arrangement surface, of a plurality of surfaces sandwiched between the both sidewalls forming the both ends of the housing case, and that displays a level of the error having occurred within the housing case.

2. The projection display apparatus according to claim 1, wherein
the first interface comprises a terminal connectable to an external device.
